(19) United States
(12) Patent Application Publication
(10) Pub. No.: US 2015/0358622 A1
(43) Pub. Date: Dec. 10, 2015

(54) Video Encoding for Real-Time Streaming Based on Audio Analysis

(71) Applicant: Empire Technology Development LLC, Wilmington, DE (US)

(72) Inventors: Hyoung-Gon LEE, Gyeonggi-Do (KR); Yang-Won JUNG, Seoul (KR)

(21) Appl. No.: 14/301,242

(22) Filed: Jun. 10, 2014

(51) Int. Cl. H04N 19/159; H04N 19/90; H04N 19/172

(52) U.S. Cl. CPC H04N 19/159; H04N 19/172; H04N 19/90

(57) ABSTRACT

Technologies are generally described for video encoding for real-time streaming based on audio analysis. In one example, a method includes analyzing, by a system comprising a processor, audio data representative of audio content associated with a video comprising video frames. The method also includes selecting a set of the video frames based on a determination that each video frame of the set of the video frames satisfies a defined condition associated with the audio content. Further, the method includes video encoding at least one video frame of the set of the video frames as an intra frame based on the audio analysis.

### TECHNICAL FIELD

The subject disclosure relates generally to video encoding and, also generally, to video encoding for real-time streaming based on audio analysis.

### BACKGROUND

With advancements in computing technology and prevalence of computing devices, usage of computers for daily activities has become commonplace. For example, users of computing devices may enjoy real-time video streaming on mobile devices that have wireless connectivity. Sometimes, a wireless network bandwidth and speed is sufficient and a user may experience high-quality video. However, at other times, the wireless network bandwidth and/or wireless network speed is insufficient and the user may experience distorted video and/or broken or paused streaming of the video.

Some video streaming systems attempt to handle the problem of insufficient wireless network bandwidth and/or speed by reducing resolution of the video. However, even with a reduced resolution there might still be distorted videos and/or broken or paused streaming due to insufficient network bandwidth and/or speed. As an example, the display of the latest frame or image of the video that is last successfully received may be frozen on the screen until a subsequent frame or image is successfully received. When the audio is received uninterrupted, even though the display is frozen, the user may become frustrated and may not understand what is occurring. Thus, the user experience is negatively impacted.

### SUMMARY

In one embodiment, a method may include analyzing, by a system comprising a processor, audio data representative of audio content associated with a video comprising video frames. The method may also include selecting a set of the video frames based on a determination that each video frame of the set of the video frames satisfies a defined condition associated with the audio content. Further, the method may include video encoding at least one video frame of the set of the video frames as an intra frame based on the audio content.

According to another embodiment, a system may include a memory storing computer-executable components and a processor, coupled to the memory. The processor is operable to execute or facilitate execution of one or more of the computer-executable components. The computer-executable components may include a content monitor configured to analyze audio data representative of audio content of video frames of a video. The computer-executable components may also include a selection manager configured to identify a set of the video frames from the video frames. The set of the video frames may have been determined to satisfy a defined condition for the audio content. Further, the computer-executable components may include a video encoder configured to encode at least one video frame of the set of the video frames as an intra frame based on the audio content.

According to another embodiment, provided is a computer-readable storage device that may include executable instructions that, in response to execution, cause a system that may include a processor to perform operations. The operations may include comparing an audio content of video frames of a video. The operations may also include identifying a set of the video frames from the video frames. The set of the video frames may include respective video frames that respectively satisfy a defined condition for the audio content. The operations also include encoding at least one video frame of the set of the video frames as an intra frame based on the audio content.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings in which:

FIG. 1 illustrates an example, non-limiting embodiment of a method for video encoding frames selected by audio analysis;

FIG. 2 illustrates an example, non-limiting embodiment of a system for video encoding for real-time streaming based on audio analysis;

FIG. 3 illustrates an example, non-limiting embodiment of a system configured to select video frames for encoding based on audio analysis;

FIG. 4 illustrates an example, non-limiting embodiment of a system for video encoding based on audio analysis and bandwidth considerations;

FIG. 5 is a flow diagram illustrating an example, non-limiting embodiment of a method for video encoding for real-time streaming based on audio analysis;

FIG. 6 is a flow diagram illustrating an example, non-limiting embodiment of a method for video encoding based on an available network bandwidth;

FIG. 7 is a flow diagram illustrating an example, non-limiting embodiment of a method for selecting video frames for encoding during low bandwidth situations;

FIG. 8 is a flow diagram illustrating an example, non-limiting embodiment of another method for video encoding;

FIG. 9 illustrates a flow diagram of an example, non-limiting embodiment of a set of operations for video encoding in accordance with at least some aspects of the subject disclosure; and

FIG. 10 is a block diagram illustrating an example computing device that is arranged for video encoding for real-time streaming based on audio analysis in accordance with at least some embodiments of the subject disclosure.

### DETAILED DESCRIPTION

### Overview

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, may be arranged, substituted, combined, separated, and designed in a wide variety of different configurations, all of which are explicitly contemplated herein.

Real-time video streaming may be enjoyed on many devices, including mobile devices with wireless connectivity. Sometimes, the wireless network bandwidth is sufficient and a user is able to experience high quality video. However, sometimes the user may experience distorted video and/or broken or paused video streaming due to insufficient wireless network bandwidth, speed, data rate, storage limitations, or due to other wireless network limitations.

Conventional techniques to handle this problem relate to reducing resolution of the video based on the current available bandwidth. However, when the available bandwidth is reduced, even temporarily, to a certain level, it is unavoidable during streaming to skip some frames or even to get pausing and/or breaking of the video. When skipping, pausing, and/or breaking of the video occurs, the latest frame (or image) of the video, which was successfully received, is frozen on the screen until another subsequent frame (or image) is successfully received.

In contrast, the bandwidth necessary for audio is relatively small. Therefore, in many cases, an audio portion of the video may be received without breaking, even though the video portion of the video is broken. In these situations, the user may rely on the received audio portion to sense what is or should be occurring in the video stream, while having the frozen image displayed on the screen.

In these instances, the frozen image is typically not aligned with the audio being output and, thus, the user may feel discomfort or confusion as to what is occurring. For example, imagine a screen in which a man hits a window. If the frozen image is showing the man standing at a window, the user may wonder what is going on when the user listens to a sound of the window breaking (because the audio is still being received). Thus, the user experience might not be enjoyable and the user may feel that s/he is missing something.

In consideration of the various issues with conventional real time video streaming systems and their limitations, one or more embodiments described herein are directed to a video encoding for real-time streaming based on audio analysis. For example, referring again to the above window breaking example of the window breaking. If the video were frozen at a certain point such that the frozen image or screen is of the man hitting the window, the user experience may be more enjoyable.

As disclosed herein, the video and audio may be contextually aligned when the bandwidth is below a threshold level. Various bandwidths may be used as the threshold level. For example, if a low-quality level for the video is adequate, a low threshold level may be selected. However, if the quality of the video should be at a higher quality level, the higher threshold level may be selected. Examples of the threshold level may be 1 Mb/second, 2.5 Mb/second, 5 Mb/second, and so on

A frame in a given time interval may be selected based on an accompanying audio. Thus, the accompanying audio may be analyzed to detect representative events or scenes in the video. Then, frames which correspond to the detected audio events may be selected as frames for video encoding as intra frames. An intra frame does not need to use data from previous frames, forward frames, or both previous frames and forward frames.

In one embodiment, a method is described herein that may include analyzing, by a system comprising a processor, audio data representative of audio content associated with a video comprising video frames. The method may also include selecting a set of the video frames based on a determination that each video frame of the set of the video frames satisfies a defined condition associated with the audio content. Further, the method may include video encoding at least one video frame of the set of the video frames as an intra frame based on the audio content.

According to an example, selecting the set of the video frames may include selecting the set of the video frames based on a determination that the set of the video frames satisfies a defined temporal condition.

According to another example, selecting the video frames may include determining that an amount of video frames of the set of the video frames for a given interval is above a threshold amount. Further to this example, the selecting may include selecting the set of the video frames for the given interval in an order comprising at least one of the following. Selecting a first video frame of the set of the video frames based on a first determination that the first video frame satisfies the defined condition associated with the audio content. Selecting a second video frame of the set of the video frames based on a second determination that the second video frame satisfies another defined condition associated with a video content. Selecting a third video frame of the set of the video frames based on a third determination that the third video frame satisfies a defined temporal condition.

In accordance with an example, analyzing audio data representative of audio content may include monitoring energy data representative of an energy level associated with the audio content. Further to this example, selecting the set of the video frames may include selecting a video frame of the set of the video frames based on a determination that an abrupt change in the energy level occurred at the video frame as compared to at least one other video frame.

According to another example, analyzing audio data representative of audio content may include monitoring level data representative of an audio level associated with the audio content. Further to this example, selecting the set of the video frames may include selecting a video frame of the set of the video frames based on a determination that an abrupt change in the audio level occurred at the video frame as compared to at least one other video frame.

In accordance with still another example, analyzing audio data representative of audio content may include detecting a frequency component associated with the audio content. Further to this example, selecting the set of video frames may include selecting a video frame of the set of the video frames based on a determination that the detected frequency is a higher frequency than a determined frequency. According to an aspect, the higher frequency may indicate an impulsive sound.

In still another example, analyzing audio data representative of audio content may include detecting an emotional response or an excited speech pattern associated with the audio content based on data resulting from a speech analysis.

According to still another example, selecting the video frame may include selecting another video frame of the set of the video frames based on another determination that the other video frame satisfies another defined condition associated with a video content.

In an aspect, the intra frame may include an entire video image stored in a data stream representation.

According to another embodiment, a system is described herein that may include a memory storing computer-executable components and a processor, coupled to the memory. The processor may be operable to execute or facilitate execution of one or more of the computer-executable components. The computer-executable components may include a content monitor configured to analyze audio data representative of audio content of video frames of a video. The computer-executable components may also include a selection manager configured to identify a set of the video frames from the video frames, wherein the set of the video frames has been determined to satisfy a defined condition for the audio content. Further, the computer-executable components may include a video encoder configured to encode at least one video frame of the set of the video frames as an intra frame based on the audio content.

In an example, the selection manager may be further configured to select another video frame of the set of the video frames based on a determination that the other video frame satisfies another defined condition associated with a video content.

According to an aspect, the selection manager may be further configured to select another video frame of the set of the video frames based on a determination that the other video frame satisfies a defined temporal condition.

According to another aspect, the content monitor may be further configured to determine that an abrupt change in a level data representative of an audio level or an energy data representative of an energy level has occurred between a first video frame and a second video frame of the video frames. Further, the selection manager may be configured to encode the second video frame as an intra frame.

The content monitor, according to another example, may be further configured to detect an emotional response or an excited speech pattern associated with the audio content based on data resulting from speech analysis.

In accordance with another example, the computer-executable components may include a bandwidth analyzer that may be configured to determine that an available bandwidth is below a defined bandwidth level. Further to this example, the video encoder may be further configured to encode at least another video frame of the set of the video frames as a predicted frame or a bi-directional predicted frame.

According to another embodiment, described herein is a computer-readable storage device comprising executable instructions that, in response to execution, cause a system comprising a processor to perform operations. The operations may include comparing an audio content of video frames of a video. The operations may also include identifying a set of the video frames. The set of the video frames may include respective video frames that respectively satisfy a defined condition for the audio content. Further, the operations may include encoding at least one video frame of the set of the video frames as an intra frame based on the audio content.

In an example, the operations may include determining an available bandwidth is below a defined bandwidth level. Further to this example, the encoding may include encoding at least another video frame of the set of the video frames as a predicted frame or a bi-directional predicted frame.

In accordance with another example, the operations may include selecting the set of the video frames based on a determination that the set of the video frames satisfies a defined temporal condition.

According to another example, the operations may include determining that an abrupt change in a level data representative of an audio level or an energy data representative of an energy level has occurred between a first video frame and a second video frame. The operations may also include encoding the second video frame as another intra frame.

Herein, an overview of some of the embodiments for real-time streaming based on audio analysis has been presented above. As a roadmap for what follows next, various example, non-limiting embodiments and features for an implementation of video encoding during periods of low bandwidth are described in more detail. Then, a non-limiting implementation is given for a computing environment in which such embodiments and/or features may be implemented.

### Video Encoding for Real-Time Streaming Based on Audio Analysis

As disclosed herein, real-time streaming during periods of low bandwidth may be based on audio analysis, wherein a video frame is selected for encoding as an intra frame based on an accompanying audio. Further, according to various aspects, frames that are selected by audio analysis may be given priority as compared to other frames. For example, an intra frame may be a single frame of digital content that may be examined independent of the frames that precede and follow it. The single frame may store all of the data necessary to display that frame. Typically, the frame in which the complete image or complete data is stored is proceeded and followed by other frames (which do not have a complete image stored therein) of a compressed video.

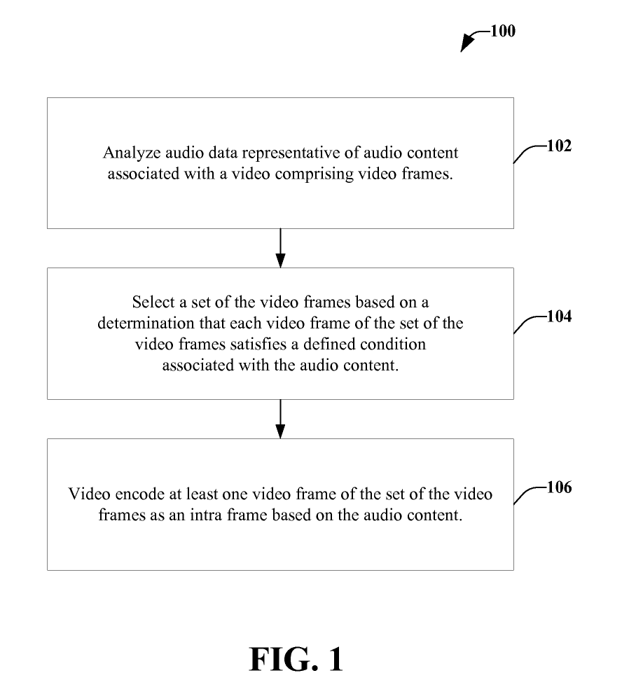

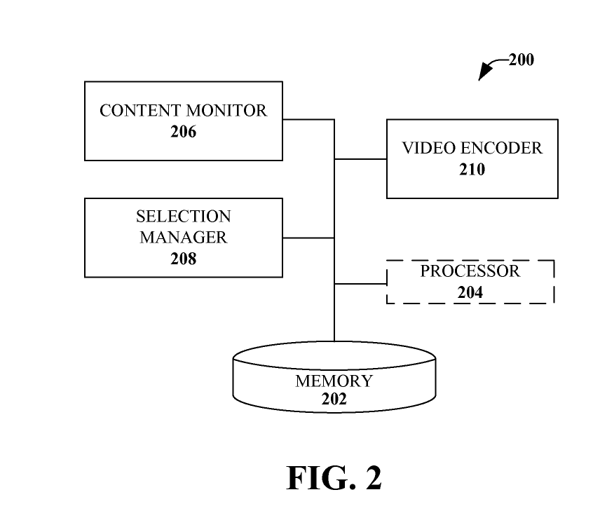

With respect to one or more non-limiting ways to manage video encoding for real-time streaming, FIG. 1 illustrates an example, non-limiting embodiment of a method 100 for video encoding frames selected by audio analysis. The method 100 in FIG. 1 may be implemented using, for example, any of the systems, such as a system 200 (of FIG. 2), described herein below. Beginning at block 102, analyze audio data representative of audio content associated with a video comprising video frames. The audio data may be analyzed based on a determination that a bandwidth does not satisfy a defined bandwidth level. Block 102 may be followed by block 104.

At 104, select a set of the video frames based on a determination that each video frame of the set of the video frames satisfies a defined condition associated with the audio content. For example, an energy data representative of an energy level associated with the audio content may be monitored. In another example, level data representative of an audio level associated with the audio content may be monitored. In a further example, a frequency component associated with the audio content may be detected.

In further detail, the accompanying audio may be analyzed to detect representative events and/or scenes in the video. In some implementations, frames that are not selected by audio analysis may be selected based on one or more other methods (e.g., regular time interval, based on video analysis, and so forth). Block 104 may be followed by block 106.

At block 106, video encode at least one video frame of the set of the video frames as an intra frame based on the audio content. According to some implementations, other video frames of the video frames other than the video frames in the set of the video frames are not video encoded (e.g., might be dropped) during periods of low bandwidth. In some implementations, only the selected video frames may be encoded as intra frames while the other, non-selected video frames might be encoded as predicted frames or as bi-directional predicted frames, during the periods of low bandwidth. According to other implementations, other video frames of the set of video frames are encoded as intra frames based on other determinations, such as based on video content, a time parameter, and so on. Further, some of the video frames in the set of video frames might be encoded as predicted frames or as bi-directional predicted frames.

For example, in video coding, there are generally about three different types of frames. These three types of frames are referred to as Intra Frame (I-frame), Predicted Frame (P-frame), and Bi-directional Predicted Frame (B-frame). An I-frame is a frame in a data stream in which a complete image (or complete data) is stored, and may be regarded as a keyframe. In order to reduce the amount of information, P-frames and B-frames are used. The P-frames and B-frames use data from previous frames, forward frames, or from both previous frames and forward frames. The more I-frames in a video, the better quality the video. However, I-frames contain a large number of bits (compared to non-I-frames) and, therefore, take up more space when stored on a storage media.

In general, an I-frame may be selected in a given time interval in order to provide random access. In some cases, an I-frame may be selected to maximize the coding efficiency. When selected to maximize the coding efficiency, the video stream may be analyzed to select the most appropriate frame in terms of coding efficiency. For example, the I-frames may be selected when a scene changes. These conventional techniques of selecting I-frames based on a time interval and/or based on scene changes may be adequate for video coding efficiency, however such techniques may not reflect the context of the scene, or be aligned with the audio.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 2 illustrates an example, non-limiting embodiment of the system 200 for video encoding for real-time streaming based on audio analysis. The system 200 may be configured to analyze video frames and select a set of the video frames for encoding as intra frames, predicted frames, or bi-directional predicted frames based on audio analysis. Further, the system 200 may be configured to utilize audio analysis to detect contextual changes in the video. For example, the system 200, may utilize energy detection, high frequency detection, impulsive sound detection, speech analysis, or other techniques for analyzing the audio portion.

The system 200 may include at least one memory 202 that may store computer-executable components and instructions. The system 200 may also include at least one processor 204, communicatively coupled to the at least one memory 202. Coupling may include various communications including, but not limited to, direct communications, indirect communications, wired communications, and/or wireless communications. The at least one processor 204 may be operable to execute or facilitate execution of one or more of the computer-executable components stored in the memory 202. The processor 204 may be directly involved in the execution of the computer-executable component(s), according to an aspect. Additionally or alternatively, the processor 204 may be indirectly involved in the execution of the computer executable component(s). For example, the processor 204 may direct one or more components to perform the operations.

It is noted that although one or more computer-executable components may be described herein and illustrated as components separate from the memory 202 (e.g., operatively connected to memory), in accordance with various embodiments, the one or more computer-executable components might be stored in the memory 202. Further, while various components have been illustrated as separate components, it will be appreciated that multiple components may be implemented as a single component, or a single component may be implemented as multiple components, without departing from example embodiments.

A content monitor 206 may be configured to analyze audio data representative of audio content of video frames of a video. In some implementations, the video content of the video may be analyzed with respect to audio content associated with each frame of the video. For example, the accompanying audio may be analyzed by the content monitor 206 to detect representative events and/or scenes in the video.

A selection manager 208 may be configured to identify a set of the video frames from the video frames. The set of the video frames may have been determined to satisfy a defined condition for the audio content.

For example, the system 200 may be configured to contextually align video and audio when the available bandwidth is not enough to stream the entire video. In some instances, the video may be skipped or paused when the network bandwidth is not at the appropriate level. However, even though the video portion may be skipped or paused, the audio portion, due to its small data size, may be continuously received and played. Thus, the paused or frozen image may not be aligned with the audio in a contextual sense. This is because, in some cases, the video coding may be performed without considering the contextual meaning of its accompanying video.

I-frames play a key role not only due to the size of the I-frames being bigger than P-frames and B-frames, but also because P-frames and B-frames cannot be decoded without the I-frames. Thus, when the bandwidth is not sufficient for entire frames (e.g., I-frame, P-frame, and B-frame), I-frames should have priority. Further, I-frames should be preserved when skipping and/or pausing occurs.

Thus, the selection manager 208 may be configured to select one or more video frames based on the accompanying audio. For example, the content monitor 206 may analyze the accompanying audio to detect representative events and/or scenes in the video. Frames that correspond to the detected audio events may be selected by the selection manager 208 as frames for video encoding by a video encoder 210.

The video encoder 210 may be configured to encode at least one video frame of the set of the video frames as an I-frame based on at least the audio content. According to some implementations, other video frames may be encoded as I-frames, P-frames, or B-frames based on other considerations, such as temporal parameters and/or video analysis. In some implementations during periods of low bandwidth, one or more frames might be dropped.

Conventional systems for video encoding select an I-frame in a given interval, and when a scene changes. For example, some conventional systems use one I-frame (or key frame) about every ten seconds. Other conventional systems insert one I-frame every two seconds, and so on. However, these periodically selected frames may not be the representative image. Further, an I-frame selected by video analysis (based on detecting scene changes) may not be the representative image in a contextual sense.

Accordingly, the system 200 may consider that the scene is contextually changed where there is a change in the audio portion. Thus, although the scene might not be significantly changed according to the perspective of image/video coding/processing, the viewer's perception of those changes may be significantly different. These changes may be detected by the content monitor 206 through audio analysis.

By way of example, consider a scene in which a robber aims a gun at a victim. In a next scene, the robber actually shoots the gun. The two scenes may not be different in terms of the video portion. However, the two scenes are different in a contextual sense. Although video analysis may conclude the two scenes are similar, the audio is different for the two scenes because of the sharp and loud gunshot sound.

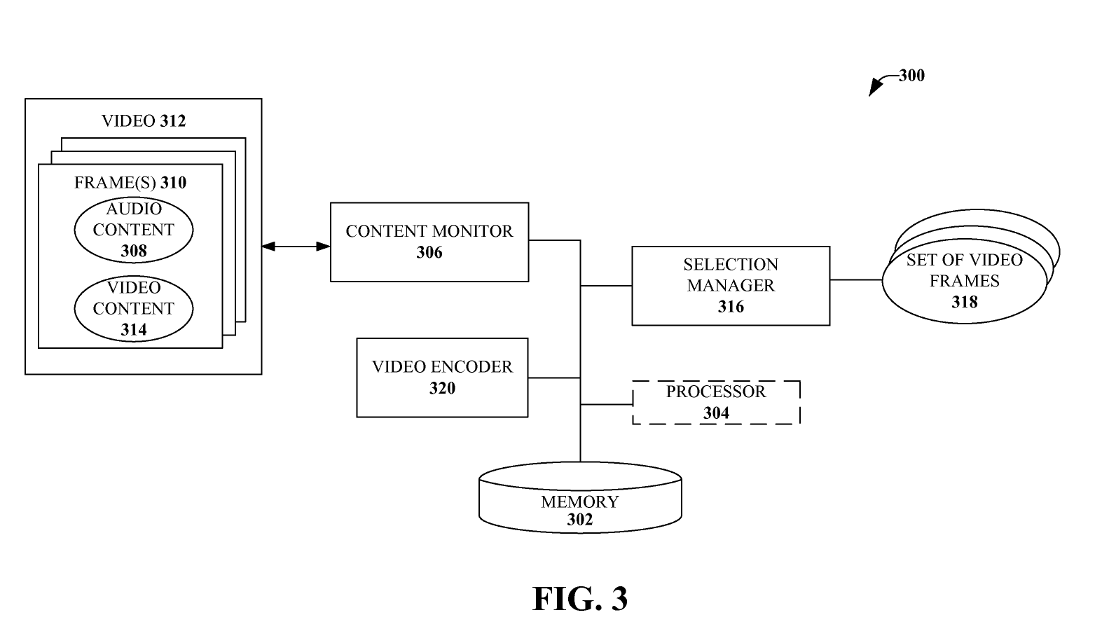

FIG. 3 illustrates an example, non-limiting embodiment of a system 300 configured to select video frames for encoding based on audio analysis. The system 300 may include at least one memory 302 that may store computer-executable components and instructions. The system 300 may also include at least one processor 304, communicatively coupled to the at least one memory 302. The at least one processor 304 may execute or may facilitate execution of one or more of the computer-executable components stored in the memory 302.

As illustrated, a content monitor 306 may be configured to analyze audio data representative of audio content 308 of video frames 310 of a video 312. The video 312 may include raw video data that may include an accompanying audio stream. Each video frame of the video frames 310 represents a slice (or a single image) that includes the audio content 308 and video content 314. The video content 314 represents pure video (or image) data without accompanying audio. In some implementations, the content monitor 306 may be configured to analyze video data representative of the video content 314 of the video frames 310 of the video 312.

According to an implementation, the content monitor 306 may be configured to determine that an abrupt change in a level data representative of an audio level or an energy data representative of an energy level has occurred between a first video frame and a second video frame of the video frames 310. For example, the first video frame and the second video frame may be contiguous video frames or may be non-contiguous video frames.

According to another implementation, the content monitor 306 may be configured to detect an emotional response or an excited speech pattern associated with the audio content based on data resulting from speech analysis.

In various implementations, the content monitor 306 may be configured to utilize audio analysis to detect contextual changes in the video. There are many metrics and/or features that may be utilized by the content monitor 306 to analyze the audio. A few examples of theses metrics and/or features include energy detection, high frequency detection, impulsive sound detection, speech analysis, and so forth.

For example, the content monitor 306 may be configured to monitor an energy data representative of an energy level of the audio content 308 and detect whether there is an abrupt change in the audio. In another example, the content monitor 306 may be configured to monitor level data representative of an audio level and detect if there is an abrupt change in the audio level.

According to another example, the content monitor 306 may be configured to detect an impulsive sound, such as a gunshot, a window breaking, a car crash, and so on. Further, the content monitor 306 may be configured to detect whether the video contains high frequency in the audio.

In still another example, the content monitor 306 may be configured to detect excited speech. In a further example, the content monitor 306 may be configured to detect an emotional response. It should be noted that other metrics and/or features may be utilized by the content monitor 306 to perform the audio analysis and the above are merely some examples.

A selection manager 316 may be configured to identify a set of the video frames 318 from the video frames 310 that may have been determined to satisfy a defined condition for the audio content. The set of the video frames 318 represent a set of candidate video frames that might be encoded as I-frames. The set of video frames 318 are not yet encoded, only selected as candidates, and, therefore, may be regarded as raw data.

For example, the content monitor 306 may determine a level data representative of an audio level or an energy data representative of an energy level changed between a first video frame and a second video frame, which might be contiguous frames or non-contiguous frames. Further to this example, the selection manager 316 may be configured to select the second video frame for inclusion in the set of the video frames 318.

According to another example, the content monitor 306 may determine an emotional response or an excited speech pattern associated with the audio content, and identified through speech analysis, in at least one video frame of the set of video frames satisfies the defined condition. Further to this example, the selection manager 316 may be configured to select the at least one video frame to be encoded as an intra frame.

According to some implementations, the selection manager 316 may be configured to select the set of the video frames 318 based on a determination that the set of the video frames satisfies a defined temporal condition.

In an example, the selection manager 316 may be configured to select candidate I-frames periodically, such as one I-frame every two seconds, or based on another selection criteria. According to another example, the selection manager 316 may be configured to selected candidate I-frames based on video analysis and/or based on audio analysis.

Further, the selection manager 316 may be configured to select I-frames from among the candidate I-frames. This further selection may be made to maintain coding efficiency. For example if the number of candidate I-frames for a given time frame is higher than a threshold number of I-frames, the selection manager 316 may be configured to select candidate I-frames based on audio analysis. The other candidate I-frames might be dropped.

For example, assume there are three candidate I-frames in a given time frame (e.g., two seconds). A first candidate I-frame is selected by the selection manager 316 based on audio analysis, a second candidate I-frame is selected by the selection manager 316 based on video analysis, and a third candidate I-frame is selected by the selection manager 316 based on a periodic selection. Further to this example, the threshold number of I-frames is two frames. Thus, the selection manager 316 may be configured to give preference or priority to the I-frame selected from the audio analysis. A next preference or priority may be given to the I-frame selected from periodic. Thus, in this example, the I-frame candidate selected from video analysis is disregarded, or given the lowest level priority.

According to some alternative or additional aspects, the selection manager 316 may assign priority to the candidate I-frames based on audio analysis. It is possible that a channel is substandard for a period of time (e.g., 10 seconds). In this case, even I-frames may need to be dropped during the transmission.

For example, there may be six I-frames during a specific period of time (10 seconds in this example). This represents five I-frames per every two seconds, and one I-frame from audio analysis. Therefore, priority may be given to the candidate I-frames selected from audio analysis. Here, since priority is given on the I-frame from audio, it may be possible that the I-frame from audio is successfully received even if the other five I-frames are dropped (e.g., not transmitted).

Giving priority to the I-frames may be implemented in various ways and the disclosed aspects are not limited to any particular implementation. For example, in one embodiment, providing more bits may be utilized and in another example, look ahead may be considered.

A video encoder 320 may be configured to encode at least one video frame of the set of the video frames 318 as an I-frame based on the audio content 308. According to some implementations, the video frames encoded as I-frames are the set of video frames selected by the selection manager 316 and the other video frames that are not selected by the selection manager 316 are encoded as P-frames or as B-frames during the periods of low bandwidth. This implementation may reduce the amount of bandwidth needed to stream the video to a user device. A user device may be a cellular telephone, a cordless telephone, a Session Initiation Protocol (SIP) phone, a smart phone, a feature phone, a wireless local loop (WLL) station, a personal digital assistant (PDA), a laptop, a handheld communication device, a handheld computing device, a netbook, a tablet, a satellite radio, a data card, a wireless modem card and/or another processing device for communicating over a wireless system.

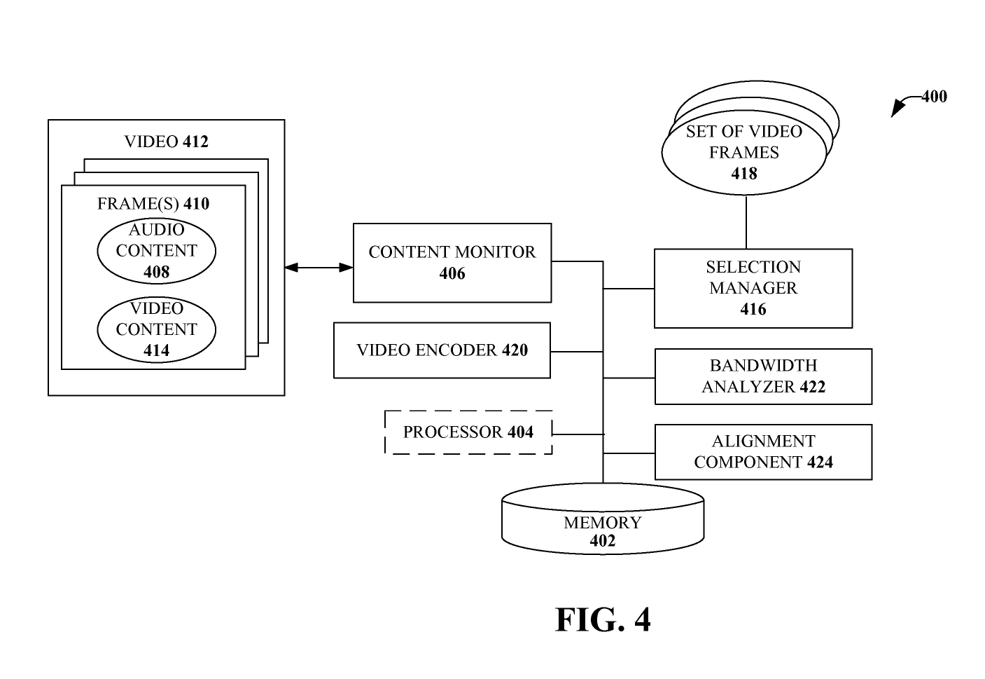

FIG. 4 illustrates an example, non-limiting embodiment of a system 400 for video encoding based on audio analysis and bandwidth considerations. The system 400 may include at least one memory 402 and at least one processor 404, communicatively coupled to the at least one memory 402. The memory 402 may store computer-executable components and instructions. The at least one processor 404 may execute or may facilitate execution of one or more of the computer-executable components stored in the memory 402.

Also included in the system 400 may be a content monitor 406 that may be configured to analyze audio data representative of audio content 408 of video frames 410 of a video 412. According to some implementations, the content monitor 406 may be configured to analyze video data representative of video content 414 of the video frames 410 of the video 412. The video 412 may have any number of video frames 410. The analysis by the content monitor 406 may include audio level analysis, energy level analysis, emotional level response analysis, excited speech pattern analysis, other forms of speech analysis, and so on.

The system 400 may also include a selection manager 416 that may be configured to identify a set of the video frames 418 from the video frames as candidate I-frames. Further, the set of the video frames selected by the selection manager 416 may be those frames that have been determined to satisfy a defined condition for the audio content. A video encoder 420 may be configured to encode at least one video frame of the set of the video frames 418 as an I-frame based on the audio content.

According to some implementations, the selection manager 416 may be further configured to select another video frame of the set of video frames based on a determination that the other video frame satisfies another defined condition associated with a video content. For example, the frames might satisfy a condition related to audio aspects, temporal aspects, and/or video aspects.

Further, the system 400 may include a bandwidth analyzer 422 that may determine that an available bandwidth is below a defined bandwidth level. The threshold level may be selected based on various factors including, but not limited to, a quality level of the video, the number of simultaneous users accessing the video, the number of other users accessing a video hosting service, a number of other users accessing an internet connection, other applications running on a user device, and so on. The video encoder 420 may be configured to encode at least another video frame of the set of video frames as an I-frame, a P-frame, or as a B-frame.

An alignment component 424 may be configured to align the video content and the audio content of the set of the video frames within the available bandwidth.

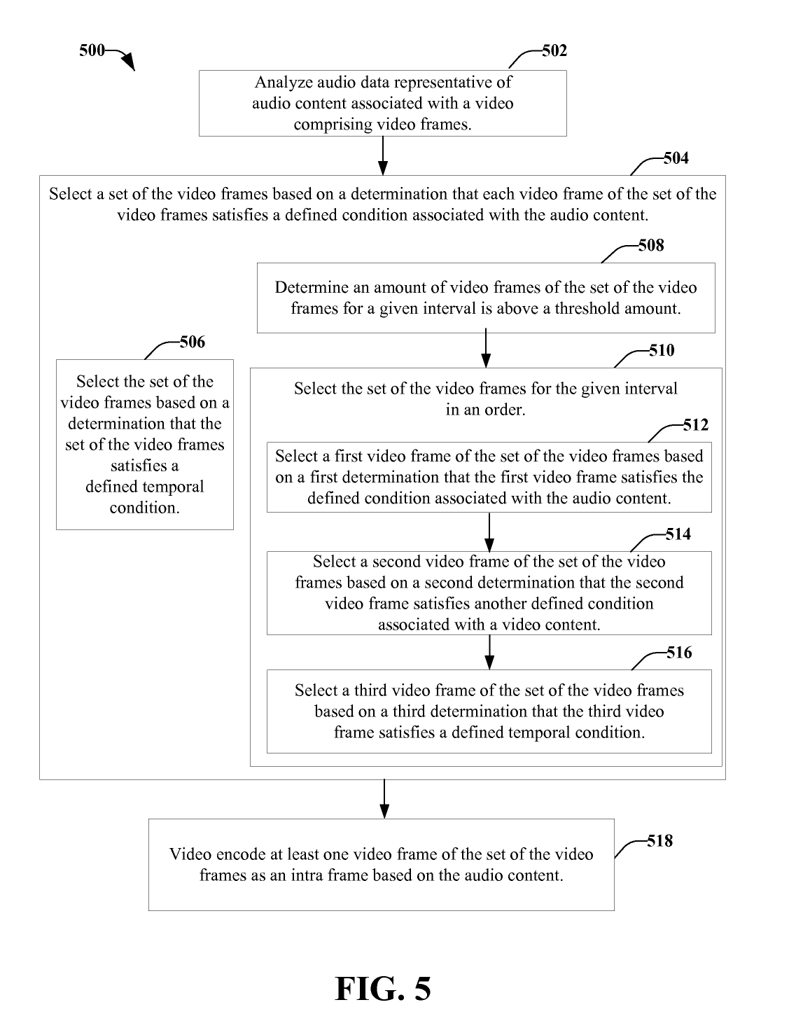

FIG. 5 is a flow diagram illustrating an example, non-limiting embodiment of a method 500 for video encoding for real-time streaming based on audio analysis. The flow diagram in FIG. 5 may be implemented using, for example, any of the systems, such as the system 400 (of FIG. 4), described herein.

Beginning at block 502, analyze audio data representative of audio content associated with a video that includes video frames. For example, each video frame of a video has a video portion and an audio portion. At least the audio data of the audio portion may be analyzed at block 502. Block 502 may be followed by block 504.

At block 504, select a set of the video frames based on a determination that each video frame of the set of the video frames satisfies a defined condition associated with the audio content. For example, the defined condition may be based on audio analysis. According to some implementations, other defined conditions may be based on video analysis and/or periodic selection. Block 504 may include block 506, or alternatively, may include block 508 and block 510.

At block 506, select the set of the video frames based on a determination that the set of the video frames satisfies a defined temporal condition. For example, the set of the video frames may be selected periodically (e.g., one I-frame every 3 seconds, one I-frame every 4 seconds, and so on).

In an alternative implementation, at block 508, determine that an amount of video frames of the set of the video frames for a given interval is above a threshold amount. Block 508 may be followed by block 510. At block 510, select the set of the video frames for the given interval in an order that includes at least one of block 512, block 514, or block 516.

At block 512, select a first video frame of the set of the video frames based on a first determination that the first video frame satisfies the defined condition associated with the audio content. For example, if a first frame has a first audio level and another frame has a second audio level that is at least a certain percentage higher than the first audio level, then the other frame may satisfy the defined condition.

At block 514, select a second video frame of the set of the video frames based on a second determination that the second video frame satisfies another defined condition associated with the video content. For example, if a first video frame depicts a man standing at a window and a subsequent frame depicts a man hitting the window, the subsequent frame may satisfy the defined condition.

At block 516, select a third video frame of the set of the video frames based on a third determination that the third video frame satisfies a defined temporal condition. For example, one frame might be selected every few seconds. Block 504, 506, 510, 512, 514, or 516 may be followed by block 518.

At block 518, video encode at least one video frame of the set of the video frames as an I-frame based on the audio content. The video encoding may utilize various techniques for encoding video that are known and, therefore, such techniques will not be further discussed herein.

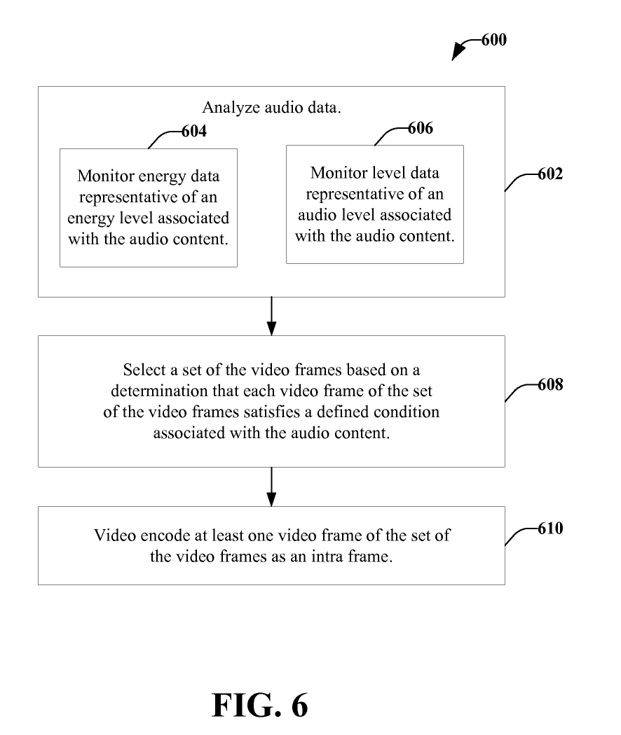

FIG. 6 is a flow diagram illustrating an example, non-limiting embodiment of a method 600 for video encoding based on an available network bandwidth. The flow diagram in FIG. 6 may be implemented using, for example, any of the systems, such as the system 300 (of FIG. 3), described herein.

Beginning at block 602, analyze at least audio data. Analyzing the audio data may include analyzing audio data representative of audio content associated with a video comprising video frames. Block 602 may include block 604 and/or block 606.

At block 604, monitor energy data representative of an energy level associated with the audio content. Alternatively or in addition, at block 606, monitor level data representative of an audio level associated with the audio content. Bock 602, block 604, or block 606 may be followed by block 608.

At block 608, select a set of the video frames based on a determination that each video frame of the set of the video frames satisfies a defined condition associated with the audio content. For example, based on monitoring energy data representative of the energy level at block 604, the selection at block 608 may include selecting a video frame of the set of the video frames based on a determination that an abrupt change in the energy level occurred at the video frame as compared to at least one other video frame.

In another example, based on monitoring level data representative of the audio level at block 606, the selection at block 608 may include selecting a video frame of the set of the video frames based on a determination that an abrupt change in the audio level occurred at the video frame as compared to at least one other video frame. Block 608 may be followed by block 610.

At block 610, video encode at least one video frame of the set of the video frames as an I-frame. The other video frames of the video frames which were not selected might be dropped when not enough bandwidth is available. In some implementations, the other video frames might be encoded as P-frames or B-frames.

For example, ten video frames might be selected for the set of the video frames based on audio analysis with a defined condition. However, the bandwidth is only available for seven video frames. Thus, three of the video frames cannot be encoded as I-frames and, therefore, may be encoded as B-frames or P-frames.

In another example, all the video frames (in raw data) could be video encoded. The difference between the set of the video frames and the other video frames may be that the set of the video frames are encoded as I-frames and the other frames are encoded as P-frames or B-frames. Further, if the bandwidth is not enough, some video frames of the set of the video frames may be encoded as I-frames, and the other video frames of the set of the video frames, and other video frames which are not selected for inclusion in the set of the video frames, may be encoded as P-frames or B-frames.

However, if the frame rate of raw data is, for example, 60 frames per second and the target frame rate of the encoded video is, for example, 30 frames per second, some of the video frames are not encoded at all. For example, these video frames are not included in the encoded video and, therefore, are not encoded as I-frames, P-frames, or P-frames.

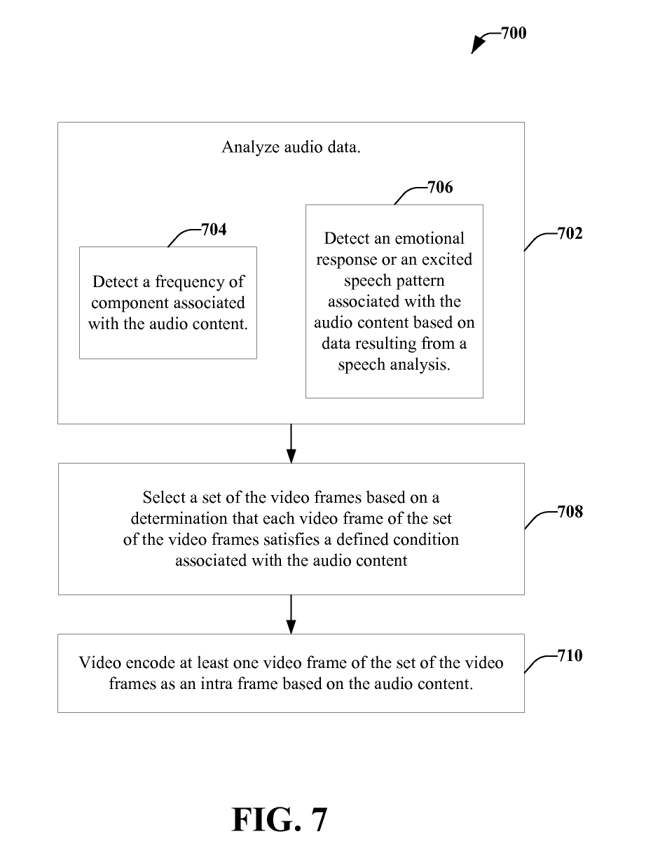

FIG. 7 is a flow diagram illustrating an example, non-limiting embodiment of a method 700 for selecting video frames for encoding during low bandwidth situations. The flow diagram in FIG. 7 may be implemented using, for example, any of the systems, such as the system 300 (of FIG. 3), described herein.

Beginning at block 702, analyze audio data representative of audio content associated with a video comprising video frames. Block 702 may include block 704 and/or block 706.

At block 704, detect a frequency component associated with the audio content. Alternatively or in addition, at block 706, detect an emotional response or an excited speech pattern associated with the audio content based on data resulting from a speech analysis. Block 702, block 704, or block 706 may be followed by block 708.

At block 708, select a set of the video frames based on a determination that each video frame of the set of the video frames satisfies a defined condition associated with the audio content. According to an implementation, the selection can include selection of a video frame of the set of the video frames based on a determination that the detected frequency is a higher frequency than a determined frequency, which may be an expected frequency, an average frequency, or based on other criteria. The higher frequency may indicate an impulsive sound. Block 708 may be followed by block 710.

At block 710, video encode at least one video frame of the set of the video frames as an I-frame based on the audio content. In some implementations, other video frames of the video frames other than the video frames in the set of the video frames are video encoded as P-frames or B-frames during periods of low bandwidth. However, in other implementations other video frames may be selected and encoded based on other parameters including audio content or a temporal condition.

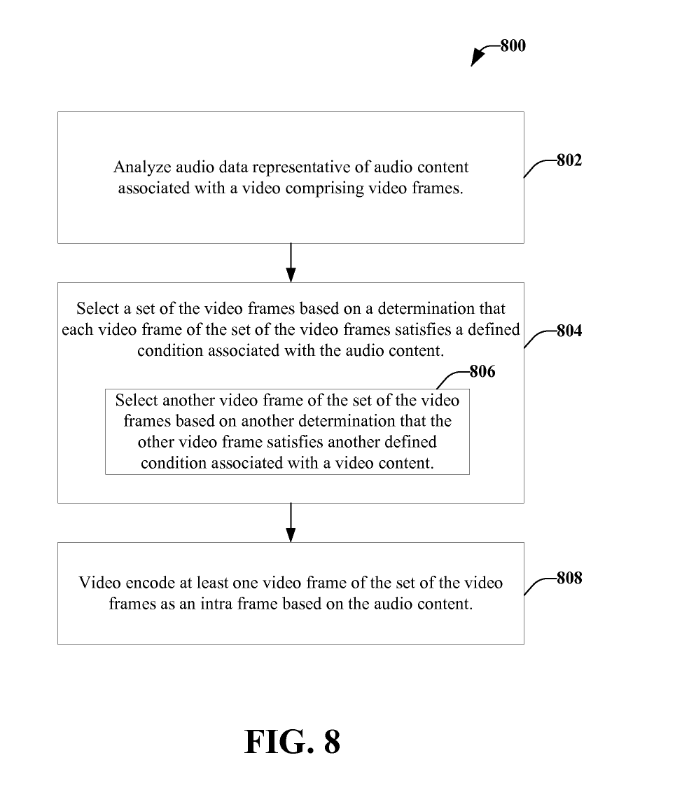

FIG. 8 is a flow diagram illustrating an example, non-limiting embodiment of another method 800 for video encoding. The flow diagram in FIG. 8 may be implemented using, for example, any of the systems, such as the system 400 (of FIG. 4), described herein.

Beginning at block 802, analyze audio data representative of audio content associated with a video comprising video frames. Block 802 may be followed by block 804.

At block 804, select a set of the video frames based on a determination that each video frame of the set of the video frames satisfies a defined condition associated with the audio content. Block 804 may include block 806.

At block 806, select another video frame of the set of the video frames based on another determination that the other video frame satisfies another defined condition associated with the video content. Block 804 and/or block 806 may be followed by block 808.

At block 808, video encode at least one video frame of the set of the video frames as an I-frame based on the audio content. The I-frame may comprise an entire video image stored in a data stream representation.

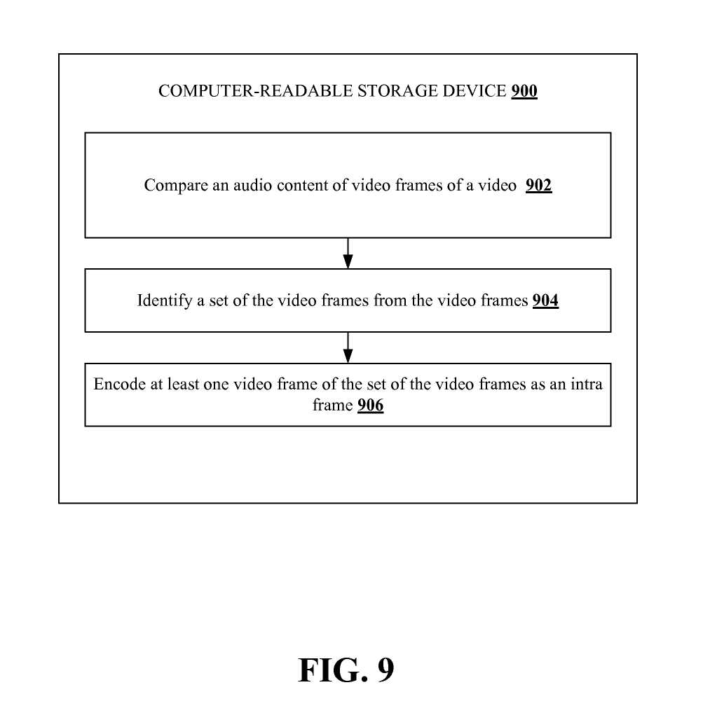

FIG. 9 illustrates a flow diagram of an example, non-limiting embodiment of a set of operations for video encoding in accordance with at least some aspects of the subject disclosure. A computer-readable storage device 900 may include computer executable instructions that, in response to execution, cause a system comprising a processor to perform operations.

At 902, the operations may cause the system to compare an audio content of video frames of a video. At 904, the operations may cause the system to identify a set of the video frames from the video frames. For example, the set of the video frames may comprise respective video frames that respectively satisfy a defined condition for the audio content. The set of the video frames represent candidate I-frames.

At 906, the operations may cause the system to encode at least one video frame of the set of the video frames as an I-frame based on the audio content Thus, a first set of video frames may be encoded as I-frames.

In an implementation, the operations may cause the system to determine an available bandwidth is below a defined bandwidth level. Further to this implementation, the encoding may include encoding at least another video frame of the set of the video frames as a P-frame or as a B-frame.

According to another implementation, the operations include selecting the set of the video frames based on a determination that the set of the video frames satisfies a defined temporal condition.

In accordance with another implementation, the operations may cause the system to determine that an abrupt change in an level data representative of an audio level or an energy data representative of an energy level has occurred between the at least one video frame and a second video frame. The at least one video frame and the second video frame may be contiguous video frames. According to some implementations, the at least one video frame and the second video frame may be non-contiguous video frames. The operations may also cause the system to encode the second video frame as another I-frame.

As discussed herein, various non-limiting embodiments are directed to video encoding for real-time streaming based on audio analysis. The audio analysis may be based on comparison between video frames or based on other considerations such as periodic and/or video analysis. A set of video frames may be selected as candidate I-frames based on the analysis and one or more video frames of this set of video frames may be encoded as I-frames. Other video frames that are not selected might be encoded as P-frames or B-frames.

### Example Computing Environment

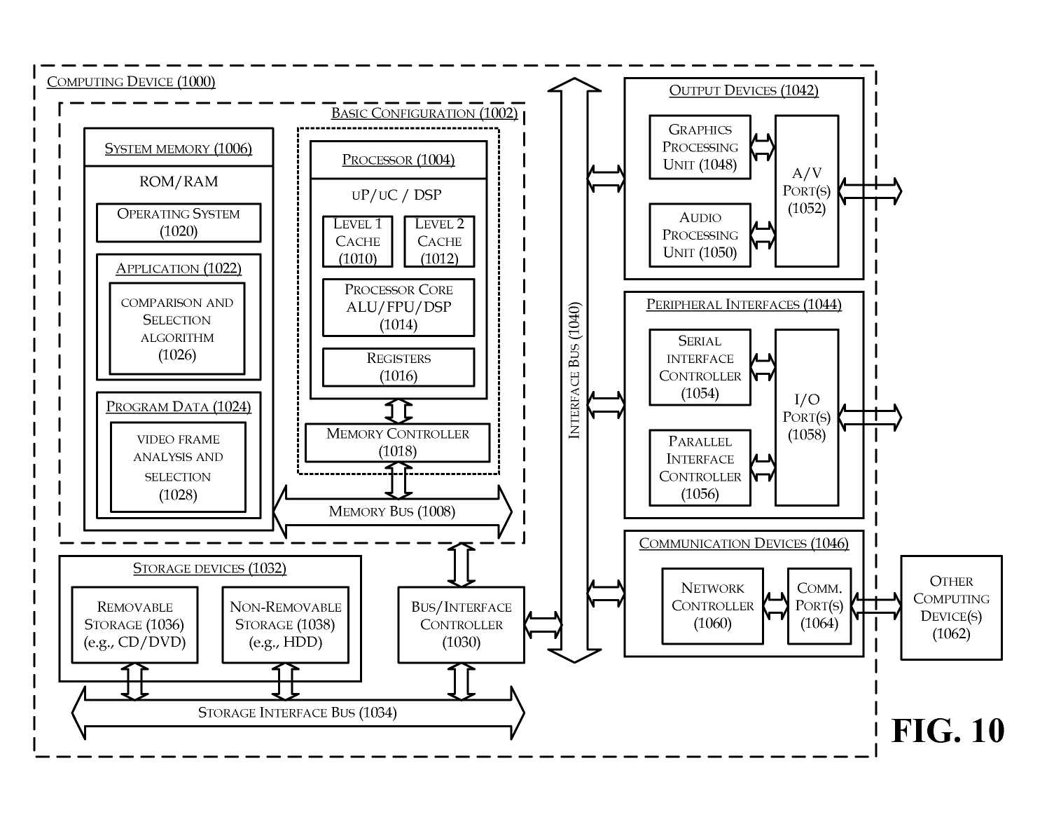

FIG. 10 is a block diagram illustrating an example computing device 1000 that is arranged for video encoding for real-time streaming based on audio analysis in accordance with at least some embodiments of the subject disclosure. In a very basic configuration 1002, the computing device 1000 typically includes one or more processors 1004 and a system memory 1006. A memory bus 1008 may be used for communicating between the processor 1004 and the system memory 1006.

Depending on the desired configuration, the processor 1004 may be of any type including but not limited to a microprocessor (W), a microcontroller (1E), a digital signal processor (DSP), or any combination thereof. The processor 1004 may include one more levels of caching, such as a level one cache 1010 and a level two cache 1012, a processor core 1014, and registers 1016. An example processor core 1014 may include an arithmetic logic unit (ALU), a floating point unit (FPU), a digital signal processing core (DSP Core), or any combination thereof. An example memory controller 1018 may also be used with the processor 1004, or in some implementations, the memory controller 1018 may be an internal part of the processor 1004.

In an example, the processor 1004 may execute or facilitate execution of the instructions to perform operations that may include comparing an audio content of video frames of a video. The operations may also include identifying a set of the video frames from the video frames. The set of the video frames may include respective video frames that respectively satisfy a defined condition for the audio content. Further, the operations may include encoding at least one video frame of the set of the video frames as I-frames based on the audio content.

According to an implementation, the operations may include determining an available bandwidth is below a defined bandwidth level. Further to this implementation, the encoding may include encoding at least another video frame of the set of the video frames as a P-frame or as a B-frame.

In accordance with another implementation, the operations may include selecting the set of the video frames based on a determination that the set of the video frames satisfies a defined temporal condition.

According to another implementation, the operations may include determining that an abrupt change in a level data representative of an audio level or an energy data representative of an energy level has occurred between a first video frame and a second video frame. The first video frame and the second video frame may be contiguous video frames, or non-contiguous video frames. The operations may also include encoding the second video frame as another I-frame.

Depending on the desired configuration, the system memory 1006 may be of any type including but not limited to volatile memory (such as RAM), non-volatile memory (such as ROM, flash memory, etc.) or any combination thereof. The system memory 1006 may include an operating system 1020, one or more applications 1022, and program data 1024. The applications 1022 may include a comparison and selection algorithm 1026 that is arranged to perform the functions as described herein including those described with respect to the system 400 of FIG. 4. The program data 1024 may include video frame analysis and selection 1028 that may be useful for operation with the comparison and selection algorithm 1026 as is described herein. In some embodiments, the applications 1022 may be arranged to operate with the program data 1024 on the operating system 1020 such that video encoding for real-time streaming based on audio analysis may be provided. This described basic configuration 1002 is illustrated in FIG. 10 by those components within the inner dashed line.

The computing device 1000 may have additional features or functionality, and additional interfaces to facilitate communications between the basic configuration 1002 and any required devices and interfaces. For example, a bus/interface controller 1030 may be used to facilitate communications between the basic configuration 1002 and one or more data storage devices 1032 via a storage interface bus 1034. The data storage devices 1032 may be removable storage devices 1036, non-removable storage devices 1038, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 1006, the removable storage devices 1036, and the non-removable storage devices 1038 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 1000. Any such computer storage media may be part of the computing device 1000.

The computing device 1000 may also include an interface bus 1040 for facilitating communication from various interface devices (e.g., output devices 1042, peripheral interfaces 1044, and communication devices 1046) to the basic configuration 1002 via the bus/interface controller 1030. Example output devices 1042 include a graphics processing unit 1048 and an audio processing unit 1050, which may be configured to communicate to various external devices such as a display or speakers via one or more A/V ports 1052. Example peripheral interfaces 1044 include a serial interface controller 1054 or a parallel interface controller 1056, which may be configured to communicate with external devices such as input devices (e.g., mouse, pen, voice input device, etc.) or other peripheral devices (e.g., printer, scanner, etc.) via one or more I/O ports 1058. An example communication device 1046 includes a network controller 1060, which may be arranged to facilitate communications with one or more other computing devices 1062 over a network communication link via one or more communication ports 1064.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The subject disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The subject disclosure is to be limited only by the terms of the appended claims, along with the full scope of equivalents to which such claims are entitled. It is to be understood that this disclosure is not limited to particular methods, reagents, compounds, compositions or biological systems, which may, of course, vary. It is also to be understood that the terminology used herein is for the purpose of describing particular embodiments only, and is not intended to be limiting.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems; the use of hardware or software is generally (but not always, in that in certain contexts the choice between hardware and software may become significant) a design choice representing cost versus efficiency tradeoffs. There are various vehicles by which processes and/or systems and/or other technologies described herein may be effected (e.g., hardware, software, and/or firmware), and that the selected vehicle will vary with the context in which the processes and/or systems and/or other technologies are deployed. For example, if an implementer determines that speed and accuracy are paramount, the implementer may select a mainly hardware and/or firmware vehicle; if flexibility is paramount, the implementer may select a mainly software implementation; or, yet again alternatively, the implementer may select some combination of hardware, software, and/or firmware.

The foregoing detailed description has set forth various embodiments of the devices and/or processes via the use of block diagrams, flowcharts, and/or examples. In so far as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Further, designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiments of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples and that in fact many other architectures may be implemented which achieve a similar functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably coupleable”, to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” and the like include the number recited and refer to ranges, which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While the various aspects have been elaborated by various figures and corresponding descriptions, features described in relation to one figure are included in the aspects as shown and described in the other figures. Merely as one example, the “content monitor” described in relation to FIG. 4 is also a feature in the aspect as shown in FIG. 2, FIG. 3, and so forth.

From the foregoing, it will be appreciated that various embodiments of the subject disclosure have been described herein for purposes of illustration, and that various modifications may be made without departing from the scope and spirit of the subject disclosure. Accordingly, the various embodiments disclosed herein are not intended to be limiting, with the true scope and spirit being indicated by the following claims.

What is claimed is:

1. A method, comprising:
analyzing, by a system comprising a processor, audio data representative of audio content associated with a video comprising video frames;
selecting a set of the video frames based on a determination that each video frame of the set of the video frames satisfies a defined condition associated with the audio content; and
video encoding at least one video frame of the set of the video frames as an intra frame based on the audio content.

2. The method of claim 1, wherein the selecting further comprises:
selecting the set of the video frames based on a determination that the set of the video frames satisfies a defined temporal condition.

3. The method of claim 1, wherein the selecting further comprises:
determining that an amount of video frames of the set of the video frames for a given interval is above a threshold amount; and
selecting the set of the video frames for the given interval in an order comprising at least one of:
selecting a first video frame of the set of the video frames based on a first determination that the first video frame satisfies the defined condition associated with the audio content,
selecting a second video frame of the set of the video frames based on a second determination that the second video frame satisfies another defined condition associated with a video content, or
selecting a third video frame of the set of the video frames based on a third determination that the third video frame satisfies a defined temporal condition.

4. The method of claim 1, wherein the analyzing comprises:
monitoring energy data representative of an energy level associated with the audio content,
wherein the selecting comprises selecting a video frame of the set of the video frames based on a determination that an abrupt change in the energy level occurred at the video frame as compared to at least one other video frame.

5. The method of claim 1, wherein the analyzing comprises:
monitoring level data representative of an audio level associated with the audio content,
wherein the selecting comprises selecting a video frame of the set of the video frames based on a determination that an abrupt change in the audio level occurred at the video frame as compared to at least one other video frame.

6. The method of claim 1, wherein the analyzing comprises:
detecting a frequency component associated with the audio content,
wherein the selecting comprises selecting a video frame of the set of the video frames based on a determination that the detected frequency is a higher frequency than a determined frequency.

7. The method of claim 6, wherein the higher frequency indicates an impulsive sound.

8. The method of claim 1, wherein the analyzing comprises:
detecting an emotional response or an excited speech pattern associated with the audio content based on data resulting from a speech analysis.

9. The method of claim 1, wherein the selecting further comprises:
selecting another video frame of the set of the video frames based on another determination that the other video frame satisfies another defined condition associated with a video content.

10. The method of claim 1, wherein the intra frame comprises an entire video image stored in a data stream representation.

11. A system, comprising:
a memory storing computer-executable components; and
a processor, coupled to the memory, operable to execute or facilitate execution of one or more of the computer-executable components, the computer-executable components comprising:
a content monitor configured to analyze audio data representative of audio content of video frames of a video;
a selection manager configured to identify a set of the video frames from the video frames, wherein the set of the video frames has been determined to satisfy a defined condition for the audio content; and
a video encoder configured to encode at least one video frame of the set of the video frames as an intra frame based on the audio content.

12. The system of claim 11, wherein the selection manager is further configured to select another video frame of the set of the video frames based on a determination that the other video frame satisfies another defined condition associated with the video content.

13. The system of claim 11, wherein the selection manager is further configured to select another video frame of the set of the video frames based on a determination that the other video frame satisfies a defined temporal condition.

14. The system of claim 11, wherein the content monitor is further configured to determine that an abrupt change in an audio data representative of an audio level or an energy data representative of an energy level has occurred between a first video frame and a second video frame of the video frames, and wherein the video encoder is further configured to encode the second video frame as an intra frame.

15. The system of claim 11, wherein the content monitor is further configured to detect an emotional response or an excited speech pattern associated with the audio content based on data resulting from speech analysis.

16. The system of claim 11, wherein the computer-executable components further comprise:
a bandwidth analyzer configured to determine that an available bandwidth is below a defined bandwidth level,
wherein the video encoder is further configured to encode at least another video frame of the set of the video frames as a predicted frame or a bi-directional predicted frame.

17. A computer-readable storage device comprising executable instructions that, in response to execution, cause a system comprising a processor to perform operations, comprising:
comparing an audio content of video frames of a video;
identifying a set of the video frames from the video frames, wherein the set of the video frames comprises respective video frames that respectively satisfy a defined condition for the audio content; and
encoding at least one video frame of the set of the video frames as an intra frame based on the audio content.

18. The computer-readable storage device of claim 17, wherein the operations further comprise:
determining an available bandwidth is below a defined bandwidth level,
wherein the encoding comprises encoding at least another video frame of the set of the video frames as a predicted frame or a bi-directional predicted frame.

19. The computer-readable storage device of claim 17, wherein the operations further comprise:
selecting the set of the video frames based on a determination that the set of the video frames satisfies a defined temporal condition.

20. The computer-readable storage device of claim 17, wherein the operations further comprise:
determining that an abrupt change in a level data representative of an audio level or an energy data representative of an energy level has occurred between a first video frame and a second video frame,
encoding the second video frame as another intra frame.
